(19) United States
(12) Patent Application Publication
(10) Pub. No.: US 2009/0092525 A1
(43) Pub. Date: Apr. 9, 2009

(54) EXHAUST GAS CLEANING APPARATUS WITH IMPROVED CONFIGURATION ENSURING PROPER INJECTION OF REDUCING AGENT

(75) Inventor: Ataru Ichikawa, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/248,376

(22) Filed: Oct. 9, 2008

(30) Foreign Application Priority Data
Oct. 9, 2007 (JP) 2007-262985
Nov. 5, 2007 (JP) 2007-287269

(51) Int. Cl. B01D 53/94

(52) U.S. Cl. 422/177

(57) ABSTRACT

An exhaust gas cleaning apparatus for cleaning the exhaust gas from an internal combustion engine includes: an exhaust gas passage through which the exhaust gas flows; a reducing agent injector that injects a reducing agent into the exhaust gas passage; and a reduction catalyst that is provided in the exhaust gas passage downstream of the reducing agent injector to promote, at least, a reduction reaction between a component of the exhaust gas and the reducing agent. The exhaust gas passage includes a bent portion formed with a bend. The reducing agent injector is provided on the outside of the bend of the bent portion to inject the reducing agent in a direction that deviates from a tangent line, which is tangent to a central axis line of the bent portion at a downstream-side end of the bent portion, toward the inside of the bend of the bent portion.

### CROSS-REFERENCE TO RELATED APPLICATIONS

This application is based on and claims priority from Japanese Patent Applications No. 2007-262985, filed on Oct. 9, 2007, and No. 2007-287269, filed on Nov. 5, 2007, the contents of which are hereby incorporated by reference into this application.

### BACKGROUND OF THE INVENTION

1. Technical Field of the Invention

The present invention relates to an exhaust gas cleaning apparatus which works on the principle of Selective Catalytic Reduction (SCR) to clean the exhaust gas from, for example, an internal combustion engine of a motor vehicle.

2. Description of the Related Art

In recent years, various urea-SCR apparatuses (or systems) have been developed and put to practical use.

For example, as disclosed in Japanese Patent First Publications No. 2001-3737 and No. 2003-293739, a urea-SCR apparatus can serve as an exhaust gas cleaning apparatus to clean the exhaust gas from an internal combustion engine (particularly, a diesel engine) of a motor vehicle by removing NOx (i.e., nitrogen oxides) from the exhaust gas.

More specifically, the urea-SCR apparatus includes a selective reduction catalyst, an exhaust gas passage that introduces the exhaust gas from the engine to the selective reduction catalyst, and a reducing agent injector that injects an aqueous urea solution as a reducing agent into the exhaust gas passage. The injected urea solution is then hydrolyzed to produce ammonia (NH3), which flows to the selective reduction catalyst along with the exhaust gas. The selective reduction catalyst promotes reduction reactions between the NOx contained in the exhaust gas and the ammonia produced by the hydrolysis of the urea solution.

Moreover, as shown in FIG. 9, the reducing agent injector, which is designated by reference number 400, is conventionally mounted on a bent pipe 120 constituting a part of the exhaust gas passage from the outside of the bend of the bent pipe 120. Further, the reducing agent injector 400 is oriented to inject the reducing agent along the central axis line 330 of a straight pipe 310 provided downstream of the bent pipe 120.

However, with the above configuration, the spray of the urea solution injected by the reducing agent injector 400 will be blown by the flow of the exhaust gas toward the outside of the bend of the bent pipe 120. Consequently, part of the spray of the urea solution may adhere to the inner walls of the bent pipe 120 and the straight pipe 310, and urea may be deposited from the part of the spray onto those inner walls. As a result, the part of the spray of the urea solution adhering to the inner walls will not be used for the reduction reactions with the NOx in the selective reduction catalyst 300, resulting in a waste of the urea solution. Further, with the deposition of urea on the inner walls of the bent and straight pipes 120 and 310, the cross-sectional area of the exhaust gas passage will be reduced, resulting in an increase in the exhaust gas pressure inside the exhaust gas passage.

FIG. 10 shows another conventional configuration, wherein the reducing agent injector 400 injects the urea solution into a straight pipe 100 which extends in a horizontal direction and constitutes a part of the exhaust gas passage.

With the above configuration, however, the spray of the urea solution injected by the reducing agent injector 400 will come down under the force G of gravity. Consequently, part of the spray of the urea solution may adhere to the inner wall of the straight pipe 100, and urea may be deposited from the part of the spray onto the inner wall. As a result, the part of the spray of the urea solution adhering to the inner wall will not be used for the reduction reactions with the NOx in the selective reduction catalyst 300, resulting in a waste of the urea solution. Further, with the deposition of urea on the inner wall of the straight pipe 100, the cross-sectional area of the exhaust gas passage will be reduced, resulting in an increase in the exhaust gas pressure inside the exhaust gas passage.

### SUMMARY OF THE INVENTION

The present invention has been made in view of the abovementioned problems.

It is, therefore, a primary object of the present invention to provide an exhaust gas cleaning apparatus which has an improved configuration ensuring a proper injection of a reducing agent into an exhaust gas passage.

According to the present invention, there is provided a first exhaust gas cleaning apparatus for cleaning the exhaust gas from an internal combustion engine. The first exhaust gas cleaning apparatus includes: an exhaust gas passage through which the exhaust gas flows; a reducing agent injector that injects a reducing agent into the exhaust gas passage; and a reduction catalyst that is provided in the exhaust gas passage downstream of the reducing agent injector to promote, at least, a reduction reaction between a component of the exhaust gas and the reducing agent. Further, in the first exhaust gas cleaning apparatus, the exhaust gas passage includes a bent portion formed with a bend. The reducing agent injector is provided on the outside of the bend of the bent portion to inject the reducing agent in a direction that deviates from a tangent line, which is tangent to a central axis line of the bent portion at a downstream-side end of the bent portion, toward the inside of the bend of the bent portion.

With the above configuration, the reducing agent injected by the reducing agent injector is kept from being blown by the flow of the exhaust gas toward the outside of the bend of the bent portion. Consequently, adhesion of the reducing agent to the inner wall of the exhaust gas passage can be suppressed. As a result, the reducing agent injected by the reducing agent injector can be fully used for the at least one reduction reaction in the reduction catalyst, and reduction in the cross-sectional area of the exhaust gas passage can be prevented.

According to the present invention, there is also provided a second exhaust gas cleaning apparatus for cleaning the exhaust gas from an internal combustion engine. The second exhaust gas cleaning apparatus includes: an exhaust gas passage through which the exhaust gas flows; a reducing agent injector that injects a reducing agent into the exhaust gas passage; and a reduction catalyst that is provided in the exhaust gas passage downstream of the reducing agent injector to promote, at least, a reduction reaction between a component of the exhaust gas and the reducing agent. Further, in the second exhaust gas cleaning apparatus, the exhaust gas passage includes a bent portion formed with a bend. The reducing agent injector has an injection centerline along which the reducing agent is injected by the reducing agent injector. The reducing agent injector is provided on the outside of the bend of the bent portion to inject the reducing agent with the injection centerline offset from a tangent line, which is tangent to a central axis line of the bent portion at a downstream-side end of the bent portion, toward the inside of the bend of the bent portion.

With the above configuration, the second exhaust gas cleaning apparatus can achieve the same advantages as the first exhaust gas cleaning apparatus described above.

According to the present invention, there is further provided a third exhaust gas cleaning apparatus for cleaning the exhaust gas from an internal combustion engine. The third exhaust gas cleaning apparatus includes: an exhaust gas passage through which the exhaust gas flows; a reducing agent injector that injects a reducing agent into the exhaust gas passage; and a reduction catalyst that is provided in the exhaust gas passage downstream of the reducing agent injector to promote, at least, a reduction reaction between a component of the exhaust gas and the reducing agent. Further, in the third exhaust gas cleaning apparatus, a reducing agent-flowing section of the exhaust gas passage, through which the reducing agent flows from the reducing agent injector to the reduction catalyst, is configured to be arranged in an exhaust system of the engine with the reducing agent injector positioned vertically higher than the reduction catalyst.

With the above configuration, the component of the force of gravity acting on the reducing agent in the direction perpendicular to the inner wall of the reducing agent-flowing section can be reduced. Consequently, the amount of the reducing agent adhering to the inner wall of the reducing agent-flowing section can be accordingly reduced. In addition, even if part of the reducing agent adheres to the inner wall of the reducing agent-flowing section, the part of the reducing agent will fall down to the reduction catalyst. As a result, the reducing agent injected by the reducing agent injector can be fully used for the at least one reduction reaction in the reduction catalyst, and reduction in the cross-sectional area of the exhaust gas passage can be prevented.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is a schematic view showing the overall configuration of a urea-SCR (Selective Catalytic Reduction) apparatus according to the first embodiment of the invention;

FIG. 2 is a schematic view showing the overall configuration of a urea-SCR apparatus according to the second embodiment of the invention;

FIG. 3 is a schematic view showing the overall configuration of a urea-SCR apparatus according to the third embodiment of the invention;

FIG. 4 is a schematic view showing the overall configuration of a urea-SCR apparatus according to the fourth embodiment of the invention;

FIG. 5 is a schematic view showing the overall configuration of a urea-SCR apparatus according to the fifth embodiment of the invention;

FIG. 6 is a schematic view illustrating the setting of a spray angle of a reducing agent injector in the urea-SCR apparatus of FIG. 5;

FIG. 7 is a schematic view illustrating a modification of the urea-SCR apparatus of FIG. 5;

FIG. 8 is a schematic view illustrating another modification of the urea-SCR apparatus of FIG. 5;

FIG. 9 is a schematic view showing a conventional configuration of a urea-SCR apparatus; and

FIG. 10 is a schematic view showing another conventional configuration of a urea-SCR apparatus.

### DESCRIPTION OF PREFERRED EMBODIMENTS

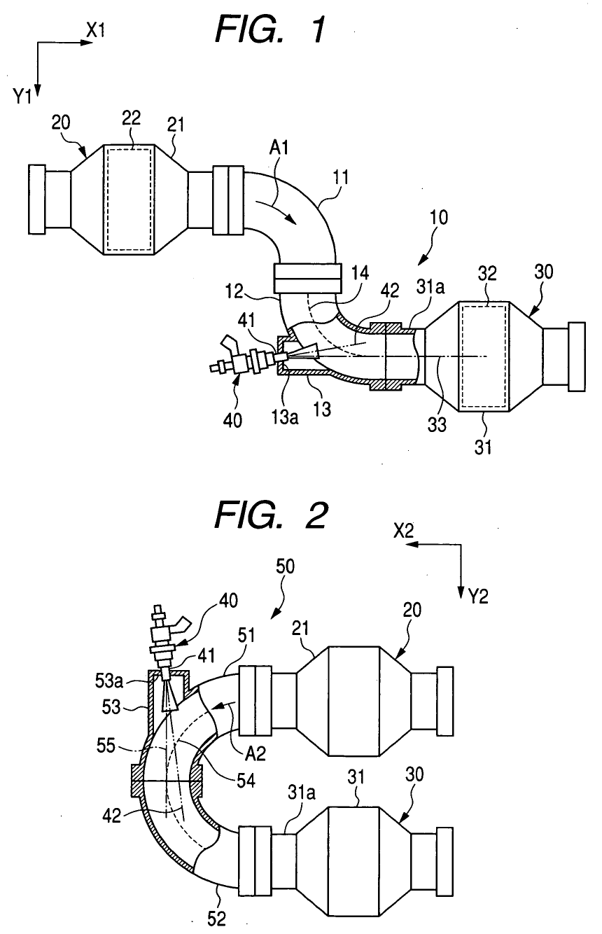

Preferred embodiments of the present invention will be described hereinafter with reference to FIGS. 1-6.

It should be noted that, for the sake of clarity and understanding, identical components having identical functions in different embodiments of the invention have been marked, where possible, with the same reference numbers in each of the figures.

### First Embodiment

FIG. 1 shows the overall configuration of a urea-SCR (Selective Catalytic Reduction) apparatus 10 according to the first embodiment of the invention. The urea-SCR apparatus 10 is designed as an exhaust gas cleaning apparatus to clean the exhaust gas from a diesel engine of a motor vehicle.

In FIG. 1, the urea-SCR apparatus 10 is installed to the exhaust system of the engine and viewed in a horizontal direction. In addition, in FIG. 1, arrow X1 indicates a horizontal direction, while arrow Y1 indicates the vertically downward direction.

More specifically, the urea-SCR apparatus 10 is mounted to a most-downstream portion of an exhaust manifold of the engine. As shown in FIG. 1, the urea-SCR apparatus 10 includes a DPF (Diesel Particulate Filter) 20, a bent pipe 11, a bent pipe 12, and a SCR catalyst 30, which are connected in series along the exhaust gas flow from the upstream side to the downstream side. Moreover, in the urea-SCR apparatus 10, there is formed an exhaust gas passage that extends through the insides of a case 21 of the DPF 20, the bent pipes 11 and 12, and a case 31 of the SCR catalyst 30. The exhaust gas flows through the exhaust gas passage as indicated with arrow A1 in FIG. 1.

The DPF 20 and the SCR catalyst 30 are so arranged that the exhaust gas flows in the horizontal direction X1 in both the DPF 20 and the SCR catalyst 30. Further, the DPF 20 is positioned vertically higher than the SCR catalyst 30, and connected to the SCR catalyst 30 via the bent pipes 11 and 12.

The bent pipe 11 is connected between the case 21 of the DPF 20 and the bent pipe 12 to change the flow direction of the exhaust gas from the horizontal direction X1 to the vertically downward direction Y1. On the other hand, the bent pipe 12 is connected between the bent pipe 11 and the case 31 of the SCR catalyst 30 to change the flow direction of the exhaust gas from the vertically downward direction Y1 to the horizontal direction X1.

The case 31 of the SCR catalyst 30 includes a straight-pipe portion 31a that is connected to the bent pipe 12 and extends horizontally. More specifically, the straight-pipe portion 31a is so connected to the bent pipe 12 that the central axis line 33 of the straight-pipe portion 31a is tangent to the central axis line 14 of the bent pipe 12 at the downstream-side end of the bent pipe 12.

The DPF 20 includes a honeycomb-structured DPF support 22, which is received in the case 21 of the DPF 20. The DPF 20 is a continuously regenerable filter designed to remove PM (Particulate Matter) from the exhaust gas. The DPF support 22 supports a platinum-based oxidation catalyst (not shown) to remove SOF (Soluble Organic Fraction), which is a kind of PM, as well as HC and CO from the exhaust gas.

The bent pipe 12 has, on the outside of the bend, a protruding portion 13 on which is mounted a reducing agent injector 40 of the urea-SCR apparatus 10.

More specifically, the protruding portion 13 is formed, on the outside of the bend of the bent pipe 12, into a hollow cylinder protruding in a direction opposite to the horizontal direction X1. The protruding portion 13 opens to the inside of the bent pipe 12, with its central axis line coinciding with the central axis line 33 of the straight-pipe portion 31a of the case 31 of the SCR catalyst 30. The protruding portion 13 has an end wall 13a, through the center of which a nozzle portion 41 of the reducing agent injector 40 is inserted into the protruding portion 13.

With the above arrangement, the nozzle portion 41 of the reducing agent injector 40 is directly exposed to the inside of the protruding portion 13, not to the inside of the bent pipe 12, thus reducing the amount of heat transmitted from the exhaust gas to the nozzle portion 41.

The reducing agent injector 40 is configured to inject an aqueous urea solution through an injection hole formed in the nozzle portion 41, thereby forming a spray of the urea solution in the bent pipe 12. The urea solution is, as a reducing agent, pressurized and supplied to the reducing agent injector 40 by a urea solution supply system (not shown). The spray of the urea solution formed in the bent pipe 12 is then converted into ammonia (NH3), with heat transmitted from the exhaust gas, through the following reaction:

(NH2)2CO+H2O→2NH3+CO2 (1)

Consequently, the spray of the urea solution flowing through the exhaust gas passage comes to include ammonia; however, for the sake of convenience, it will be still referred to as “spray of the urea solution” hereinafter. The spray of the urea solution flows, along with the exhaust gas, to the SCR catalyst 30.

The SCR catalyst 30 includes a honeycomb-structured catalyst support 32, which is received in the case 31 of the SCR catalyst 30. The catalyst support 32 supports metal catalysts, such as vanadium oxide (V2O5). The SCP catalyst 30 promotes the following reduction reactions between the NOx contained in the exhaust gas and the ammonia contained in the spray of the urea solution:

4NO+4NH3+O2→4N2+6H2O (2)

6NO2+8NH3→7N2+12H2O (3)

NO+NO2+2NH3→2N2+3H2O (4)

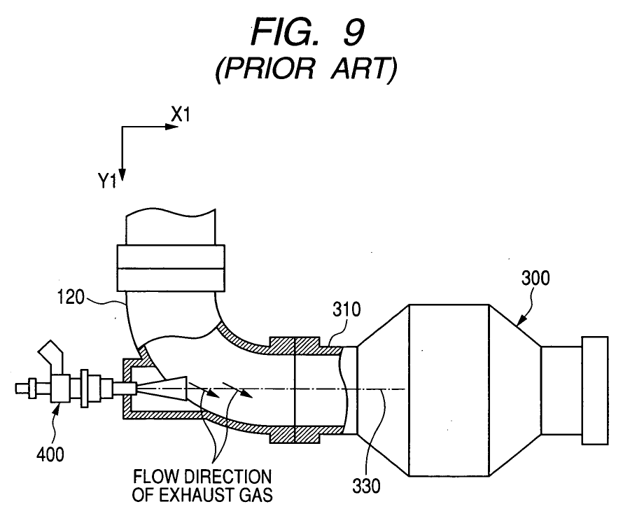

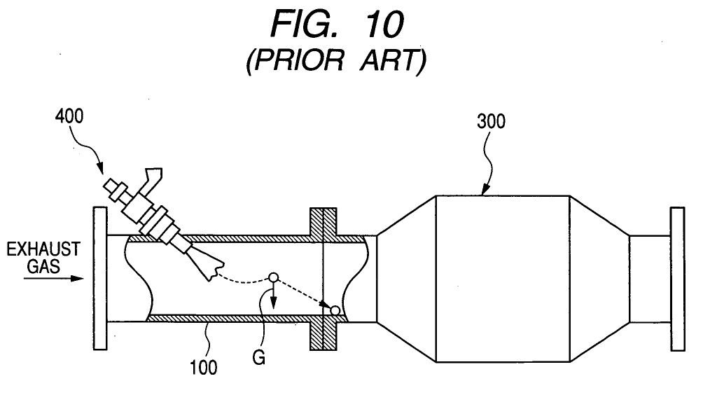

To suppress adhesion of the spray of the urea solution to the inner wall of the exhaust gas passage, it is desirable that the spray of the urea solution be formed at an even distance from the inner wall of the exhaust gas passage over the entire circumference of the inner wall. To this end, one may consider configuring the reducing agent injector 40 to inject the urea solution along the central axis line 33 of the straight-pipe portion 31a, as in the case of the conventional urea-SCR apparatus illustrated in FIG. 9.

However, in the bent pipe 12, the flow direction of the exhaust gas intersects the central axis line 33 of the straight-pipe portion 31a. In other words, the flow velocity of the exhaust gas has, on the central axis line 33, a component in the vertically downward direction Y1. Therefore, if the reducing agent injector 40 was configured to inject the urea solution along the central axis line 33, the spray of the urea solution would be blown by the flow of the exhaust gas in the vertically downward direction Y1. Consequently, part of the spray of the urea solution might adhere to the inner wall of the bent pipe 12 on the outside of the bend and the inner wall of the straight-pipe portion 31a on the vertically lower side, and thus urea might be deposited from the part of the spray onto those inner walls.

In consideration of the above, the inventor of the present invention has devised the configuration of the Urea-SCR apparatus 10 according to the present embodiment.

In the present embodiment, the reducing agent injector 40 is configured to inject the urea solution in a direction that deviates from the central axis line 33 toward the inside of the bend of the bent pipe 12. More specifically, the reducing agent injector 40 is so mounted to the end wall 13a of the protruding portion 13 of the bent pipe 12 that the spray centerline 42 of the injection hole formed in the nozzle portion 41 of the reducing agent injector 40 deviates from the central axis line 33 of the straight-pipe portion 31a toward the inside of the bend of the bent pipe 12. The spray centerline 42 represents the injection centerline of the reducing agent injector 40, along which the urea solution is injected by the reducing agent injector 40, and is thus to be referred to the injection centerline 42 of the reducing agent injector 40 hereinafter. Further, as described previously, the central axis line 33 of the straight-pipe portion 31a is tangent to the central axis line 14 of the bent pipe 12 at the downstream-side end of the bent pipe 12. That is to say, in the present embodiment, the reducing agent injector 40 is configured to inject the urea solution in a direction that deviates from a tangent line 33, which is tangent to the central axis line 14 of the bent pipe 12 at the downstream-side end of the bent pipe 12, toward the inside of the bend of the bent pipe 12.

With the above configuration, the spray of the urea solution injected by the reducing agent injector 40 is kept from being blown by the flow of the exhaust gas toward the outside of the bend of the bent pipe 12. Consequently, adhesion of the spray of the urea solution to the inner walls of the bent pipe 12 and the straight-pipe portion 31a, and thus deposition of urea from the spray of the urea solution onto the inner walls can be suppressed.

As a result, the urea solution injected by the reducing agent injector 40 can be fully used for the reduction reactions with the NOx contained in the exhaust gas in the SCR catalyst 30. Further, without deposition of urea on the inner walls of the bent pipe 12 and the straight-pipe portion 31a, reduction in the cross-sectional area of the exhaust gas passage can be prevented.

### Second Embodiment

This embodiment illustrates a urea-SCR apparatus 50 which has a similar configuration to the urea-SCR apparatus 10 according to the first embodiment. Accordingly, only the differences therebetween will be described hereinafter.

FIG. 2 shows the overall configuration of the urea-SCR apparatus 50 according to the present embodiment, where the apparatus 50 is installed to the exhaust system of a diesel engine of a motor vehicle and viewed in the vertically downward direction. In addition, in FIG. 2, arrows X2 and Y2 respectively represent two horizontal directions which are perpendicular to each other.

As shown in FIG. 2, the urea-SCR apparatus 50 includes a DPF 20, a bent pipe 51, a bent pipe 52, and a SCR catalyst 30, which are connected in series along the exhaust gas flow from the upstream side to the downstream side. Moreover, in the urea-SCR apparatus 50, there is formed an exhaust gas passage that extends through the insides of a case 21 of the DPF 20, the bent pipes 51 and 52, and a case 31 of the SCR catalyst 30. The exhaust gas flows through the exhaust gas passage as indicated with arrow A2 in FIG. 2.

The DPF 20 and the SCR catalyst 30 are so arranged that the exhaust gas flows through the DPF 20 in the horizontal direction X2, and through the SCR catalyst 30 in a horizontal direction opposite to X2 (i.e., −X2). Further, the DPF 20 and the SCR catalyst 30 are located on the same horizontal plane, and are connected to each other via the bent pipes 51 and 52.

The bent pipes 51 and 52 together form a semi-ring. More specifically, the bent pipe 51 is connected between the case 21 of the DPF 20 and the bent pipe 52 to change the flow direction of the exhaust gas from the horizontal direction X2 to the horizontal direction Y2. On the other hand, the bent pipe 52 is connected between the bent pipe 51 and the case 31 of the SCR catalyst 30 to change the flow direction of the exhaust gas from the horizontal direction Y2 to the horizontal direction −X2.

The bent pipe 51 has, on the outside of the bend, a protruding portion 53 on which is mounted a reducing agent injector 40 of the urea-SCR apparatus 50.

More specifically, the protruding portion 53 is formed, on the outside of the bend of the bent pipe 51, into a hollow cylinder protruding in a direction opposite to the horizontal direction Y2. The protruding portion 53 opens to the inside of the bent pipe 51, with its central axis line passing through the center of the downstream-side end of the bent pipe 51. The protruding portion 53 has an end wall 53a, through the center of which a nozzle portion 41 of the reducing agent injector 40 is inserted into the protruding portion 53.

In the present embodiment, the reducing agent injector 40 is configured to inject a urea solution in a direction that deviates from a tangent line 55, which is tangent to the central axis line 54 of the bent pipe 51 at the downstream-side end of the bent pipe 51, toward the inside of the bend of the bent pipe 51. More specifically, the reducing agent injector 40 is so mounted to the end wall 53a of the protruding portion 53 of the bent pipe 51 that the injection centerline 42 of the reducing agent injector 40 deviates from the tangent line 55 toward the inside of the bend of the bent pipe 51.

With the above configuration, the spray of the urea solution injected by the reducing agent injector 40 is kept from being blown by the flow of the exhaust gas toward the outside of the bend of the bent pipe 51. Consequently, adhesion of the spray of the urea solution to the inner walls of the bent pipes 51 and 52, and thus deposition of urea from the spray of the urea solution onto the inner walls can be suppressed.

As a result, the urea solution injected by the reducing agent injector 40 can be fully used for the reduction reactions with the NOx contained in the exhaust gas in the SCR catalyst 30. Further, without deposition of urea on the inner walls of the bent pipes 51 and 52, reduction in the cross-sectional area of the exhaust gas passage can be prevented.

### Third Embodiment

This embodiment illustrates a urea-SCR apparatus 60 which has almost the same configuration as the urea-SCR apparatus 10 according to the first embodiment. Accordingly, only the differences therebetween will be described hereinafter.

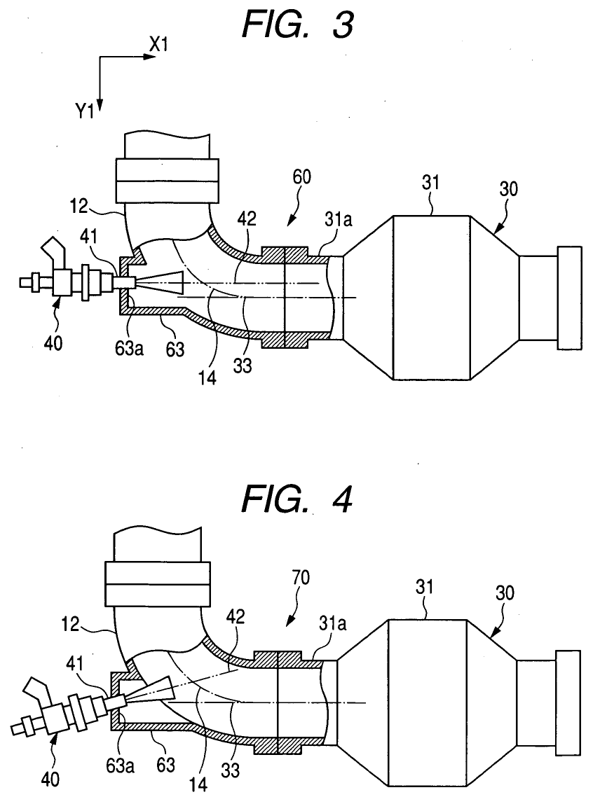

FIG. 3 shows the overall configuration of the urea-SCR apparatus 60 according to the present embodiment, where the apparatus 60 is installed to the exhaust system of a diesel engine of a motor vehicle and viewed in a horizontal direction. In addition, in FIG. 1, arrow X1 indicates a horizontal direction, while arrow Y1 indicates the vertically downward direction.

The urea-SCR apparatus 60 includes a DPF 20, a bent pipe 11, a bent pipe 12, and a SCR catalyst 30. The DPF 20 and bent pipe 11 of the urea-SCR apparatus 60 are respectively identical to those of the urea-SCR apparatus 10, and are thus omitted from FIG. 3.

The bent pipe 12 has, on the outside of the bend, a protruding portion 63 on which is mounted a reducing agent injector 40 of the urea-SCR apparatus 60.

More specifically, the protruding portion 63 is formed, on the outside of the bend of the bent pipe 12, into a hollow cylinder protruding in a direction opposite to the horizontal direction X1. The protruding portion 63 opens to the inside of the bent pipe 12, with its central axis line offset from the central axis line 33 of the straight-pipe portion 31a in the vertically upward direction. That is, the central axis line of the protruding portion 63 is offset from the central axis line 33 toward the inside of the bend of the bent pipe 12. The protruding portion 63 has an end wall 63a, through the center of which a nozzle portion 41 of the reducing agent injector 40 is inserted into the protruding portion 63.

Moreover, in the present embodiment, the reducing agent injector 40 is so mounted to the end wall 63a of the protruding portion 63 of the bent pipe 12 that the injection centerline 42 of the reducing agent injector 40 coincides with the central axis line of the protruding portion 63. Consequently, the reducing agent injector 40 injects the urea solution with the injection centerline 42 offset from the central axis line 33 of the straight-pipe portion 31a. Further, as described in the first embodiment, the central axis line 33 of the straight-pipe portion 31a is tangent to the central axis line 14 of the bent pipe 12 at the downstream-side end of the bent pipe 12. That is to say, in the present embodiment, the reducing agent injector 40 is configured to inject the urea solution with the injection centerline 42 offset from a tangent line 33, which is tangent to the central axis line 14 of the bent pipe 12 at the downstream-side end of the bent pipe 12, toward the inside of the bend of the bent pipe 12.

With the above configuration, the urea-SCR apparatus 60 can achieve the same advantages as the urea-SCR apparatus 10 according to the first embodiment.

### Fourth Embodiment

This embodiment illustrates a urea-SCR apparatus 70 which is a combination of the urea-SCR apparatus 10 and 60 according to the first and third embodiments.

More specifically, referring to FIG. 4, in the present embodiment, the reducing agent injector 40 is configured to inject the urea solution with the injection centerline 42 not only offset from the tangent line 33 toward the inside of the bend of the bent pipe 12 but also deviated from a direction parallel to the tangent line 33 toward the inside of the bend of the bent pipe 12. The tangent line 33 is, as in the first and third embodiments, tangent to the central axis line 14 of the bent pipe 12 at the downstream-side end of the bent pipe 12.

With the above configuration, it is possible to further effectively suppress adhesion of the spray of the urea solution to the inner walls of the bent pipe 12 and the straight-pipe portion 31a and to thereby further effectively suppress deposition of urea from the spray of the urea solution onto the inner walls.

### Fifth Embodiment

This embodiment illustrates a urea-SCR apparatus 80 which has a similar configuration to the urea-SCR apparatus 10 according to the first embodiment. Accordingly, only the differences therebetween will be described hereinafter.

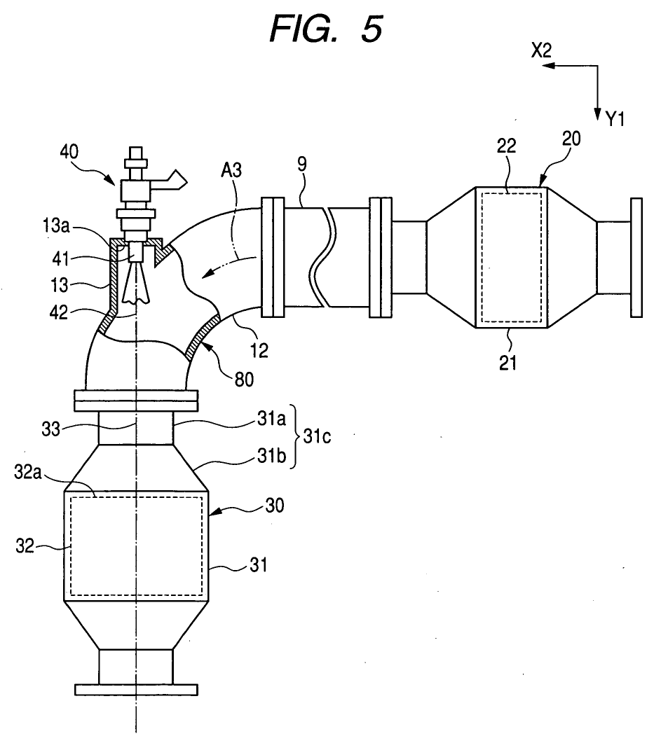

FIG. 5 shows the overall configuration of the urea-SCR apparatus 80, where the apparatus 80 is installed to the exhaust system of a diesel engine of a motor vehicle and viewed in a horizontal direction. In addition, in FIG. 5, arrow X2 indicates a horizontal direction, while arrow Y1 indicates the vertically downward direction.

As shown in FIG. 5, the urea-SCR apparatus 80 includes a DPF 20, a straight pipe 9, a bent pipe 12, and a SCR catalyst 30, which are connected in series along the exhaust gas flow from the upstream side to the downstream side. Moreover, in the urea-SCR apparatus 80, there is formed an exhaust gas passage that extends through the insides of a case 21 of the DPF 20, the straight pipe 9, the bent pipe 12, and a case 31 of the SCR catalyst 30. The exhaust gas flows through the exhaust gas passage as indicated with arrow A3 in FIG. 5.

The DPF 20 is located on the same vertical plane as the SCR catalyst 30, and positioned vertically higher than the SCR catalyst 30. The DPF 20 is so oriented that the exhaust gas flows through the DPF 20 in the horizontal direction X2. On the other hand, the SCR catalyst 30 is so oriented that the exhaust gas flows through the SCR catalyst 30 in the vertically downward direction Y1. Further, the DPF 20 and the SCR catalyst 30 are connected to each other via the straight pipe 9 and the bent pipe 12.

The straight pipe 9 is connected between the case 21 of the DPF 20 and the bent pipe 12. The straight pipe 9 is so oriented that the exhaust gas flows through the straight pipe 9 in the horizontal direction X2. The bent pipe 12 is connected between the straight pipe 9 and the case 31 of the SCR catalyst 30 to change the flow direction of the exhaust gas from the horizontal direction X2 to the vertically downward direction Y1.

The bent pipe 12 has, on the outside of the bend, a protruding portion 13 on which is mounted a reducing agent injector 40 of the urea-SCR apparatus 80.

More specifically, the protruding portion 13 is formed, on the outside of the bend of the bent pipe 12, into a hollow cylinder protruding in the vertically upward direction (i.e., −Y1 direction). The protruding portion 13 opens to the inside of the bent pipe 12, with its central axis line passing through the center of the downstream-side end of the bent pipe 12. The protruding portion 13 has an end wall 13a, through the center of which a nozzle portion 41 of the reducing agent injector 40 is inserted into the protruding portion 13.

The case 31 of the SCR catalyst 30 includes a straight-pipe portion 31a and a frustoconical-pipe portion 31b. The straight-pipe portion 31a adjoins the downward-side end of the bent pipe 12. The frustoconical-pipe portion 31b tapers from an upstream-side end 32a of the catalyst support 32 to the straight-pipe portion 31a.

In the present embodiment, a reducing agent-flowing section of the exhaust gas passage, through which the reducing agent (i.e., the urea solution) flows from the reducing agent injector 40 to the upstream-side end 32a of the catalyst support 32, is arranged in the exhaust system of the engine with the reducing agent injector 40 positioned vertically higher than the catalyst support 32.

More specifically, the reducing agent-flowing section of the exhaust gas passage includes a first portion and a second portion. The first portion is formed inside the bent pipe 12, and is thus curved. The second portion is formed inside the case 31 of the SCR catalyst 30 and extends vertically upward from the upstream-side end 32a of the catalyst support 32 to the bent pipe 12. That is, the second portion is formed inside a portion 31c of the case 31 of the SCR catalyst 30; the portion 31c includes, as shown in FIG. 5, the straight-pipe portion 31a and the frustoconical portion 31b. Hereinafter, the second portion will be referred to as vertically-extending portion of the reducing agent-flowing section.

Further, in the present embodiment, the reducing agent injector 40 is so mounted to the end wall 13a of the protruding portion 13 of the bent pipe 12 that the injection centerline 42 of the reducing agent injector 40 coincides with the central axis line 33 of the straight-pipe portion 31a of the case 31 of the SCR catalyst 30. Here, the central axis line 33 also represents the central axis line of the vertically-extending portion of the reducing agent-flowing section of the exhaust gas passage.

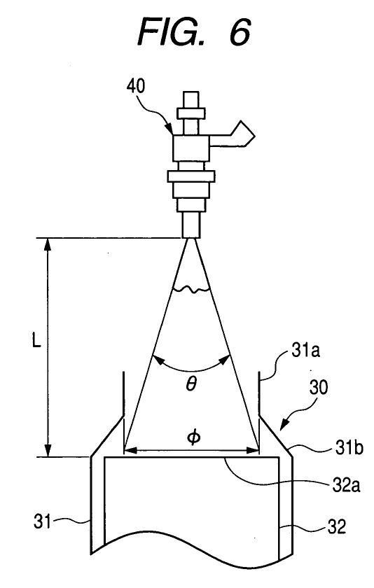

Moreover, referring to FIG. 6, the urea solution injected by the reducing agent injector 40 flows vertically downward in the reducing agent-flowing section of the exhaust gas passage, forming a substantially conical spray. To prevent adhesion of the spray of the urea solution to the inner wall of the vertically-extending portion of the reducing agent-flowing section, in the present embodiment, the spray angle θ of the reducing agent injector 40 is so set as to satisfy the following relationship:

2L×tan(θ/2)<Φ (5),

where L represents the distance between the reducing agent injector 40 and the catalyst support 32 of the SCR catalyst 30, and Φ represents the minimum diameter of the vertically-extending portion.

In addition, in the present embodiment, the minimum diameter Φ of the vertically-extending portion of the reducing agent-flowing section of the exhaust gas passage is represented by the inner diameter of the straight-pipe portion 31a of the case 31 of the SCR catalyst 30. Moreover, in the case where the spray angle θ of the reducing agent injector 40 changes according to the operating condition of the engine, it is preferable that the maximum value of θ satisfy the above relationship (5).

The above-described urea-SCR apparatus 80 according to the present embodiment has the following advantages.

In the present embodiment, the reducing agent-flowing section of the exhaust gas passage is arranged in the exhaust system of the engine with the reducing agent injector 40 positioned vertically higher than the catalyst support 32.

With the above arrangement, the component of the force of gravity acting on the spray of the urea solution in the direction perpendicular to the inner wall of the reducing agent-flowing section can be reduced. Consequently, the amount of the spray of the urea solution adhering to the inner wall of the reducing agent-flowing section can be accordingly reduced. In addition, even if part of the spray of the urea solution adheres to the inner wall of the reducing agent-flowing section, the part of the spray will become drops of the urea solution and fall down to the catalyst support 32.

As a result, the urea solution injected by the reducing agent injector 40 can be fully used for the reduction reactions with the NOx contained in the exhaust gas in the SCR catalyst 30. Further, without deposition of urea on the inner wall of the reducing agent-flowing section of the exhaust gas passage, reduction in the cross-sectional area of the exhaust gas passage can be prevented.

Moreover, in the present embodiment, the reducing agent-flowing section of the exhaust gas passage includes the vertically-extending portion formed inside the portion 31c of the case 31 of the SCR catalyst 30. The reducing agent injector 40 is configured to inject the urea solution toward the vertically-extending portion of the reducing agent-flowing section of the exhaust gas passage. More specifically, the reducing agent injector 40 is configured to inject the urea solution with the injection centerline 42 passing through the vertically-extending portion of the reducing agent-flowing section of the exhaust gas passage to reach the catalyst support 32.

In the vertically-extending portion, all the force of gravity acts on the spray of the urea solution in the vertically downward direction. Therefore, the amount of the spray of the urea solution adhering to the inner wall of the vertically-extending portion will be small. In addition, even if part of the spray of the urea solution adheres to the inner wall of the vertically-extending portion, the part of the spray will become drops of the urea solution and easily fall down to the catalyst support 32.

Further, in the present embodiment, the reducing agent injector 40 is configured to inject the urea solution with the injection centerline 42 in parallel with the vertically downward direction Y1.

With the above configuration, the injection centerline 42 of the reducing agent injector 40 is accordingly parallel to the central axis line 33 of the vertically-extending portion of the reducing agent-flowing section of the exhaust gas passage. Consequently, the component of the flow velocity of the spray of the urea solution in the direction perpendicular to the inner wall of the vertically-extending portion will be small. As a result, the amount of the spray of the urea solution adhering to the inner wall of the vertically-extending portion can be further reduced.

Furthermore, in the present embodiment, the reducing agent injector 40 is configured to inject the urea solution with the injection centerline 42 coinciding with the central axis line 33 of the vertically-extending portion of the reducing agent-flowing section of the exhaust gas passage.

With the above configuration, it is possible to effectively suppress adhesion of the spray of the urea solution to the inner wall of the vertically-extending portion even when there is a deviation of the spray centerline 42 toward the inner wall of the vertically-extending portion due to turbulence in the exhaust gas flow.

While the above particular embodiments of the present invention have been shown and described, it will be understood by those skilled in the art that various modifications, changes, and improvements may be made without departing from the spirit of the invention.

1) In the first embodiment, the urea-SCR apparatus 10 is installed to the exhaust system of the engine with the SCR catalyst 30 located vertically lower than the DPF 20.

However, the urea-SCR apparatus 10 may also be installed to the exhaust system with the SCR catalyst 30 located either vertically higher than or on the same horizontal plane as the DPF 20.

2) In the second embodiment, the urea-SCR apparatus 50 is installed to the exhaust system of the engine with the SCR catalyst 30 located on the same horizontal plane as the DPF 20.

However, the urea-SCR apparatus 50 may also be installed to the exhaust system with the SCR catalyst 30 located either vertically higher or vertically lower than the DPF 20.

3) In the third embodiment, the urea-SCR apparatus 60 is installed to the exhaust system of the engine with the SCR catalyst 30 located vertically lower than the DPF 20.

However, the urea-SCR apparatus 60 may also be installed to the exhaust system with the SCR catalyst 30 located either vertically higher than or on the same horizontal plane as the DPF 20.

4) In the fifth embodiment, the reducing agent-flowing section of the exhaust gas passage is configured with part of the bent pipe 12 and part of the case 31 of the SCR catalyst 30.

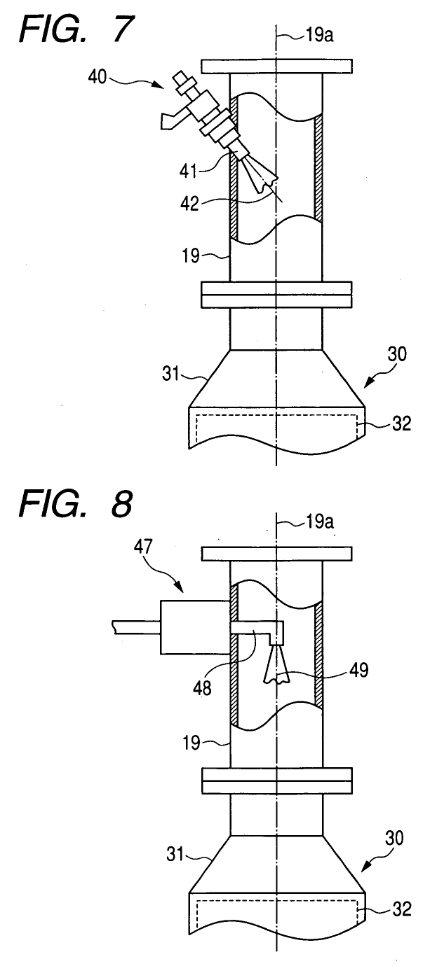

However, as shown in FIGS. 7 and 8, the reducing agent-flowing section of the exhaust gas passage may also be configured with part of a straight pipe 19 and part of the case 31 of the SCR catalyst 30.

In addition, in FIG. 8, a reducing agent injector 47 is used instead of the reducing agent injector 40. The reducing agent injector 47 has a “L”-shaped nozzle portion 48 that is inserted in the straight pipe 19 with the injection centerline 49 of the reducing agent injector 47 coinciding with the central axis line 19a of the straight pipe 19.

5) In the fifth embodiment, the reducing agent injector 40 is mounted on the protruding portion 13 of the bent pipe 12 with the injection centerline 42 in parallel with the vertically downward direction Y1.

However, the reducing agent injector 40 may also be mounted on the protruding portion 13 with the injection centerline 42 inclined to the vertically downward direction Y1.

In addition, in FIG. 8, the reducing agent injector 40 is mounted on the straight pipe 19 with the injection centerline 42 inclined to the central axis line 19a of the straight pipe 19 (i.e., inclined to the vertically downward direction).

6) In the fifth embodiment, the reducing agent injector 40 is mounted on the protruding portion 13 of the bent pipe 12 with the injection centerline 42 coinciding with the central axis line 33 of the vertically-extending portion of the reducing agent-flowing section of the exhaust gas passage.

However, the reducing agent injector 40 may also be mounted on the protruding portion 13 with the injection centerline 42 parallel to but spaced away from the central axis line 33 of the vertically-extending portion.

7) In the fifth embodiment, the reducing agent-flowing section of the exhaust gas passage is configured to include the vertically-extending portion formed inside the portion 31c of the case 31 of the SCR catalyst 30.

However, the reducing agent-flowing section of the exhaust gas passage may also be configured without such a vertically-extending portion.

8) In the previous embodiments, the reducing agent injector 40 is configured to inject the reducing agent (i.e., the aqueous urea solution), which is pressurized and supplied by a urea solution supply system, into the exhaust gas passage to form a spray of the reducing agent.

However, the reducing agent injector 40 may also be configured to inject both an un-pressurized reducing agent (e.g., an aqueous urea solution) and a pressurized gas (e.g., air) together into the exhaust gas passage to form a spray of the reducing agent.

9) The previous embodiments are directed to the urea-SCR apparatus for a diesel engine of a motor vehicle.

However, the present invention may also be applied to any exhaust gas cleaning apparatus which cleans the exhaust gas from an internal combustion engine by using a reduction catalyst to promote at least one reduction reaction between a reducing agent and a component of the exhaust gas.

What is claimed is:

1. An exhaust gas cleaning apparatus for cleaning exhaust gas from an internal combustion engine, the apparatus comprising:
an exhaust gas passage through which the exhaust gas flows;
a reducing agent injector that injects a reducing agent into the exhaust gas passage; and
a reduction catalyst that is provided in the exhaust gas passage downstream of the reducing agent injector to promote, at least, a reduction reaction between a component of the exhaust gas and the reducing agent,
wherein
the exhaust gas passage includes a bent portion formed with a bend, and
the reducing agent injector is provided on the outside of the bend of the bent portion to inject the reducing agent in a direction that deviates from a tangent line, which is tangent to a central axis line of the bent portion at a downstream-side end of the bent portion, toward the inside of the bend of the bent portion.

2. The exhaust gas cleaning apparatus as set forth in claim 1, wherein the exhaust gas passage further includes a straight-portion that adjoins the downstream-side end of the bent portion with a central axis line of the straight-portion coinciding with the tangent line, and
the reducing agent injector injects the reducing agent in the direction which deviates from the central axis line of the straight-portion toward the inside of the bend of the bent portion.

3. The exhaust gas cleaning apparatus as set forth in claim 1, wherein the reducing agent is an aqueous urea solution, and the reduction catalyst is a urea-SCR (Selective Catalytic Reduction) catalyst.

4. An exhaust gas cleaning apparatus for cleaning exhaust gas from an internal combustion engine, the apparatus comprising:
an exhaust gas passage through which the exhaust gas flows;
a reducing agent injector that injects a reducing agent into the exhaust gas passage; and
a reduction catalyst that is provided in the exhaust gas passage downstream of the reducing agent injector to promote, at least, a reduction reaction between a component of the exhaust gas and the reducing agent,
wherein
the exhaust gas passage includes a bent portion formed with a bend,
the reducing agent injector has an injection centerline along which the reducing agent is injected by the reducing agent injector, and
the reducing agent injector is provided on the outside of the bend of the bent portion to inject the reducing agent with the injection centerline offset from a tangent line, which is tangent to a central axis line of the bent portion at a downstream-side end of the bent portion, toward the inside of the bend of the bent portion.

5. The exhaust gas cleaning apparatus as set forth in claim 4, wherein the reducing agent injector injects the reducing agent with the injection centerline further deviated from a direction parallel to the tangent line toward the inside of the bend of the bent portion.

6. The exhaust gas cleaning apparatus as set forth in claim 4, wherein the exhaust gas passage further includes a straight-portion that adjoins the downstream-side end of the bent portion with a central axis line of the straight-portion coinciding with the tangent line, and
the reducing agent injector injects the reducing agent with the injection centerline offset from the central axis line of the straight-portion toward the inside of the bend of the bent portion.

7. The exhaust gas cleaning apparatus as set forth in claim 4, wherein the reducing agent is an aqueous urea solution, and the reduction catalyst is a urea-SCR (Selective Catalytic Reduction) catalyst.

8. An exhaust gas cleaning apparatus for cleaning exhaust gas from an internal combustion engine, the apparatus comprising:
an exhaust gas passage through which the exhaust gas flows;
a reducing agent injector that injects a reducing agent into the exhaust gas passage; and
a reduction catalyst that is provided in the exhaust gas passage downstream of the reducing agent injector to promote, at least, a reduction reaction between a component of the exhaust gas and the reducing agent,
wherein
a reducing agent-flowing section of the exhaust gas passage, through which the reducing agent flows from the reducing agent injector to the reduction catalyst, is configured to be arranged in an exhaust system of the engine with the reducing agent injector positioned vertically higher than the reduction catalyst.

9. The exhaust gas cleaning apparatus as set forth in claim 8, wherein the reducing agent-flowing section of the exhaust gas passage includes a vertically-extending portion which is provided on the upstream side of the reduction catalyst to extend from the reduction catalyst in the vertically upward direction, and
the reducing agent injector is configured to inject the reducing agent toward the vertically-extending portion of the reducing agent-flowing section of the exhaust gas passage.

10. The exhaust gas cleaning apparatus as set forth in claim 9, wherein the reducing agent injector has an injection centerline along which the reducing agent is injected by the reducing agent injector, and
the reducing agent injector is configured to inject the reducing agent with the injection centerline passing through the vertically-extending portion of the reducing agent-flowing section of the exhaust gas passage to reach the reduction catalyst.

11. The exhaust gas cleaning apparatus as set forth in claim 10, wherein the reducing agent injector is configured to inject the reducing agent with the injection centerline in parallel with the vertically downward direction.

12. The exhaust gas cleaning apparatus as set forth in claim 11, wherein the reducing agent injector is configured to inject the reducing agent with the injection centerline coinciding with a central axis line of the vertically-extending portion of the reducing agent-flowing section of the exhaust gas passage.

13. The exhaust gas cleaning apparatus as set forth in claim 8, wherein the reducing agent is an aqueous urea solution, and the reduction catalyst is a urea-SCR (Selective Catalytic Reduction) catalyst.
